(19) United States
(12) Patent Application Publication
(10) Pub. No.: US 2026/0205590 A1
(43) Pub. Date: Jul. 16, 2026

(54) COMPRESSING BLENDSHAPES FOR AVATAR DATA FOR AN AUGMENTED REALITY (AR) COMMUNICATION SESSION

(71) Applicant: QUALCOMM Incorporated, San Diego, CA (US)

(72) Inventors: Imed Bouazizi, Celina, TX (US); Thomas Stockhammer, Bergen (DE)

(21) Appl. No.: 19/447,969

(22) Filed: Jan. 13, 2026

Related U.S. Application Data
(60) Provisional application No. 63/745,548, filed on Jan. 15, 2025.

(51) Int. Cl. H04N 19/124; H04N 19/18; H04N 19/61

(52) U.S. Cl. CPC H04N 19/124; H04N 19/18; H04N 19/61

(57) ABSTRACT

An example device for communicating augmented reality (AR) media data includes: a memory configured to store AR media data; and a processing system implemented in circuitry and configured to: receive a base mesh of an avatar of AR media data and an encoded blendshape for the base mesh for an AR communication session; decode the encoded blendshape to reproduce a blendshape that is decoded; and present the blendshape. To decode the blendshape, the processing system may: decode a transformation matrix; decode quantized normalized values representing differences between vertices of the blendshape and corresponding vertices of the base mesh; and decode indices for the vertices of the blendshape for which the quantized normalized values are encoded.

This application claims the benefit of U.S. Provisional Application No. 63/745,548, filed Jan. 15, 2025, the entire contents of which are hereby incorporated by reference.

### TECHNICAL FIELD

This disclosure relates to transport of media data, in particular, extended reality media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The video data may be assembled into a media file conforming to any of a variety of standards, such as the International Organization for Standardization (ISO) base media file format and extensions thereof.

### SUMMARY

In general, this disclosure describes techniques for processing augmented reality (AR) media data, such as extended reality (XR) media data. XR media data may include any or all of AR data, mixed reality (MR) data, or virtual reality (VR) data. This disclosure generally describes the use of AR data, although any of the various types of XR data may be used in addition or in the alternative. During an AR communication session, a user may be represented by an avatar. The avatar may correspond to a base model. Throughout the AR communication session, the user may move their body, face, hands, or the like. These movements may be tracked by various devices, and this tracked data may be used to animate the base model of the avatar. For example, the avatar may be animated to match movements of the user, facial expressions of the user, poses of the user, or the like. This disclosure describes techniques that may be used to convert from a tracking framework to a framework for the base model to ensure that the base model can be properly animated.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network including various devices for performing the techniques of this disclosure.

FIG. 2 is a block diagram illustrating an example computing system that may perform split rendering techniques.

FIG. 3 is a flow diagram illustrating an example avatar animation workflow that may be used during an augmented reality (AR) session.

FIG. 4 is a flow diagram illustrating an example AR session between two user equipment (UE) devices and a shared space server device.

FIG. 5 is a block diagram illustrating an example user equipment (UE).

FIG. 6 is a block diagram illustrating an example set of devices that may perform various aspects of the techniques of this disclosure.

FIG. 7 is a conceptual diagram illustrating an example set of data that may be used in an AR session per techniques of this disclosure.

FIG. 8 is a block diagram illustrating an example system that may be configured to perform the techniques of this disclosure.

FIGS. 9A-9C are graphs depicting heuristic compression results for the techniques of this disclosure.

FIG. 10 is a graph depicting percentage file size reduction by quantization amount using the techniques of this disclosure.

FIG. 11 is a flowchart illustrating an example method of encoding blendshapes per the techniques of this disclosure.

FIG. 12 is a flowchart illustrating an example method of decoding blendshapes per the techniques of this disclosure.

### DETAILED DESCRIPTION

In general, this disclosure describes techniques for transporting and processing extended reality (XR) media data, such as augmented reality (AR) media data, mixed reality (MR) media data, or virtual reality (VR) media data. Immersive AR experiences are based on shared virtual spaces, where people (represented by avatars) join and interact with each other and the environment. Avatars may be realistic representations of the user or may be a “cartoonish” representation. Avatars may be animated to mimic the user's body pose and facial expressions. Users may share pre-recorded or pre-defined base avatar models, which may be animated during the AR session to represent movements of the corresponding user, such as hand gestures or facial expressions.

A display device (or another device) may capture facial movements of the user. For example, the display device may include one or more cameras or other sensors for detecting facial expressions and/or movements of the user, e.g., smiling, neutral, frowning, or mouth and jaw movements that occur when the user speaks. The display device may encode data representative of such facial movements and send the encoded data to a receiving device, such that the receiving device can animate the user's avatar consistent with the user's facial movements.

The base avatar may have several components. For facial animation, the base model may include a base mesh representing the user's neutral expression and blendshapes representing the three-dimensional (3D) head/face for a specific expression (e.g., a smile or a frown). Blendshapes may define deformations of the base mesh to represent facial expressions. A weight between 0 and 1 may be used to select the deformation. Blendshapes may be combined to reconstruct the face. For example, an output blendshape may be formed from two or more input blendshapes that may be weighted according to the weight. Thus, if v₀ represents a base mesh and v₁ to v_{N} represent blendshapes, an output mesh vₒᵤₜ may be calculated using weights w₁ to w_{N} according to:

$${v}_{out} = {v}_{0} + {\sum }_{1}^{N} {w}_{i} * ( {v}_{i} - {v}_{0} )$$

A receiving device may render received AR media data. Such rendering may be performed on a single device or using split rendering. A split rendering server may perform at least part of a rendering process to form rendered images, then stream the rendered images to a display device, such as AR glasses or a head mounted display (HMD). In general, a user may wear the display device, and the display device may capture pose information, such as a user position and orientation/rotation in real world space, which may be translated to render images for a viewport in a virtual world space.

Split rendering may enhance a user experience through providing access to advanced and sophisticated rendering that otherwise may not be possible or may place excess power and/or processing demands on AR glasses or a user equipment (UE) device. In split rendering all or parts of the 3D scene are rendered remotely on an edge application server, also referred to as a “split rendering server” in this disclosure. The results of the split rendering process are streamed down to the UE or AR glasses for display. The spectrum of split rendering operations may be wide, ranging from full pre-rendering on the edge to offloading partial, processing-extensive rendering operations to the edge.

The display device (e.g., UE/AR glasses) may stream pose predictions to the split rendering server at the edge. The display device may then receive rendered media for display from the split rendering server. The AR runtime may be configured to receive rendered data together with associated pose information (e.g., information indicating the predicted pose for which the rendered data was rendered) for proper composition and display. For instance, the AR runtime may need to perform pose correction to modify the rendered data according to an actual pose of the user at the display time.

Typical facial animation frameworks may include 50 to 80 blendshapes. Each blendshape may be a standalone mesh. The base mesh and its blendshapes may be available at different levels of detail (which may be retrieved according to, e.g., a distance between the viewer and the user in the virtual world/scene. Generally, the base model may be downloaded at the start of an AR communication session (or “AR call”). Therefore, the size of the base avatar may contribute significantly to the startup time of the call/communication session. A medium resolution/level of detail blendshape may range from 150 to 250 kB. Thus, with 50 to 80 blendshapes, the total size of the blendshapes could range between 7.5 MB to 20 MB, if sent uncompressed. Such may be even higher if multiple different levels of detail are sent, as higher levels of detail may consume even more memory, and each level of detail may need to be sent to be used based on distance from the observer to the avatar. For example, seventy different expressions and three levels of detail for each expression would result in 210 blendshapes.

This disclosure describes techniques that may be used to compress the blendshapes. In this manner, latency involved in starting the AR communication session may be reduced.

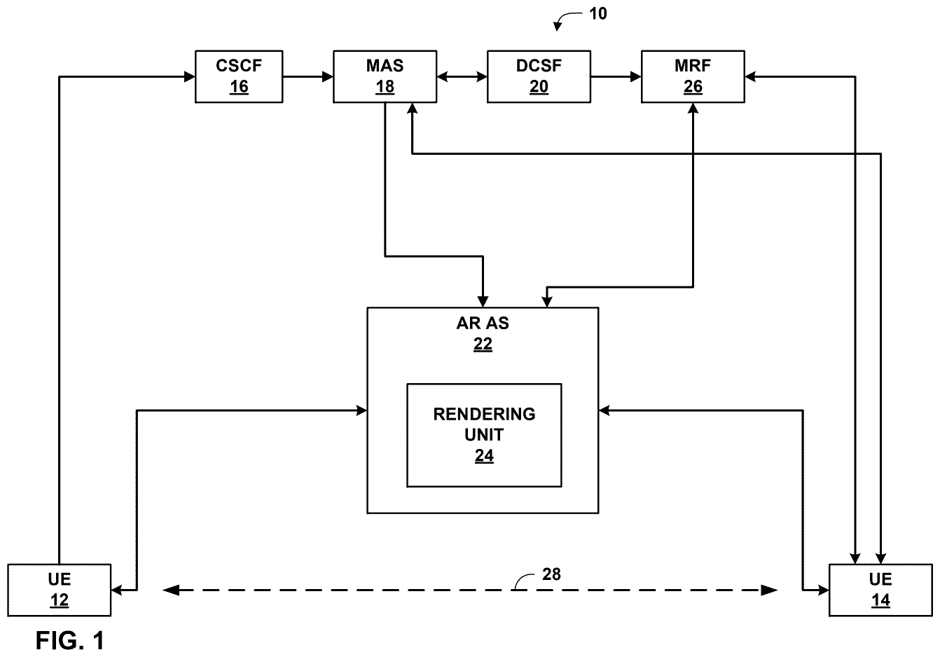

FIG. 1 is a block diagram illustrating an example network 10 including various devices for performing the techniques of this disclosure. In this example, network 10 includes user equipment (UE) devices 12, 14, call session control function (CSCF) 16, multimedia application server (MAS) 18, data channel signaling function (DCSF) 20, multimedia resource function (MRF) 26, and augmented reality application server (AR AS) 22. MAS 18 may correspond to a multimedia telephony application server, an IP Multimedia Subsystem (IMS) application server, or the like.

UEs 12, 14 represent examples of UEs that may participate in an AR communication session 28. AR communication session 28 may generally represent a communication session during which users of UEs 12, 14 exchange voice, video, and/or AR data (and/or other XR data). For example, AR communication session 28 may represent a conference call during which the users of UEs 12, 14 may be virtually present in a virtual conference room, which may include a virtual table, virtual chairs, a virtual screen or white board, or other such virtual objects. The users may be represented by avatars, which may be realistic or cartoonish depictions of the users in the virtual AR scene. The users may interact with virtual objects, which may cause the virtual objects to move or trigger other behaviors in the virtual scene. Furthermore, the users may navigate through the virtual scene, and a user's corresponding avatar may move according to the user's movements or movement inputs. In some examples, the users' avatars may include faces that are animated according to the facial movements of the users (e.g., to represent speech or emotions, e.g., smiling, thinking, frowning, or the like).

UEs 12, 14 may exchange AR media data related to a virtual scene, represented by a scene description. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the scene.

UEs 12, 14 may collect pose data for users of UEs 12, 14, respectively. For example, UEs 12, 14 may collect pose data including a position of the users, corresponding to positions within the virtual scene, as well as an orientation of a viewport, such as a direction in which the users are looking (i.e., an orientation of UEs 12, 14 in the real world, corresponding to virtual camera orientations). UEs 12, 14 may provide this pose data to AR AS 22 and/or to each other.

CSCF 16 may be a proxy CSCF (P-CSCF), an interrogating CSCF (I-CSCF), or serving CSCF (S-CSCF). CSCF 16 may generally authenticate users of UEs 12 and/or 14, inspect signaling for proper use, provide quality of service (QoS), provide policy enforcement, participate in session initiation protocol (SIP) communications, provide session control, direct messages to appropriate application server(s), provide routing services, or the like. CSCF 16 may represent one or more I/S/P CSCFs.

MAS 18 represents an application server for providing voice, video, and other telephony services over a network, such as a 5G network. MAS 18 may provide telephony applications and multimedia functions to UEs 12, 14.

DCSF 20 may act as an interface between MAS 18 and MRF 26, to request data channel resources from MRF 26 and to confirm that data channel resources have been allocated. DCSF 20 may receive event reports from MAS 18 and determine whether an AR communication service is permitted to be present during a communication session (e.g., an IMS communication session).

MRF 26 may be an enhanced MRF (eMRF) in some examples. In general, MRF 26 generates scene descriptions for each participant in an AR communication session. MRF 26 may support an AR conversational service, e.g., including providing transcoding for terminals with limited capabilities. MRF 26 may collect spatial and media descriptions from UEs 12, 14 and create scene descriptions for symmetrical AR call experiences. In some examples, rendering unit 24 may be included in MRF 26 instead of AR AS 22, such that MRF 26 may provide remote AR rendering services, as discussed in greater detail below.

MRF 26 may request data from UEs 12, 14 to create a symmetric experience for users of UEs 12, 14. The requested data may include, for example, a spatial description of a space around UEs 12, 14; media properties representing AR media that each of UEs 12, 14 will be sending to be incorporated into the scene; receiving media capabilities of UEs 12, 14 (e.g., decoding and rendering/hardware capabilities, such as a display resolution); and information based on detecting location, orientation, and capabilities of physical world devices that may be used in an audio-visual communication sessions. Based on this data, MRF 26 may create a scene that defines placement of each user and AR media in the scene (e.g., position, size, depth from the user, anchor type, and recommended resolution/quality); and specific rendering properties for AR media data (e.g., if two-dimensional (2D) media should be rendered with a “billboarding” effect such that the 2D media is configured to face the user). MRF 26 may send the scene data to each of UEs 12, 14 using a supported scene description format.

AR AS 22 may participate in AR communication session 28. For example, AR AS 22 may provide AR service control related to AR communication session 28. AR service control may include AR session media control and AR media capability negotiation between UEs 12, 14 and rendering unit 24.

AR AS 22 also includes rendering unit 24, in this example. Rendering unit 24 may perform split rendering on behalf of at least one of UEs 12, 14. In some examples, two different rendering units may be provided. In general, rendering unit 24 may perform a first set of rendering tasks for, e.g., UE 14, and UE 14 may complete the rendering process, which may include warping rendered viewport data to correspond to a current view of a user of UE 14. For example, UE 14 may send a predicted pose (position and orientation) of the user to rendering unit 24, and rendering unit 24 may render a viewport according to the predicted pose. However, if the actual pose is different than the predicted pose at the time video data is to be presented to a user of UE 14, UE 14 may warp the rendered data to represent the actual pose (e.g., if the user has suddenly changed movement direction or turned their head).

While only a single rendering unit is shown in the example of FIG. 1, in other examples, each of UEs 12, 14 may be associated with a corresponding rendering unit. Rendering unit 24 as shown in the example of FIG. 1 is included in AR AS 22, which may be an edge server at an edge of a communication network. However, in other examples, rendering unit 24 may be included in a local network of, e.g., UE 12 or UE 14. For example, rendering unit 24 may be included in a PC, laptop, tablet, or cellular phone of a user, and UE 14 may correspond to a wireless display device, e.g., AR/VR/MR/XR glasses or head mounted display (HMD). Although two UEs are shown in the example of FIG. 1, in general, multi-participant AR calls are also possible.

UEs 12, 14, and AR AS 22 may communicate AR data using a network communication protocol, such as Real-time Transport Protocol (RTP), which is standardized in Request for Comment (RFC) 3550 by the Internet Engineering Task Force (IETF). These and other devices involved in RTP communications may also implement protocols related to RTP, such as RTP Control Protocol (RTCP), Real-time Streaming Protocol (RTSP), Session Initiation Protocol (SIP), and/or Session Description Protocol (SDP).

In general, an RTP session may be established as follows. UE 12, for example, may receive an RTSP describe request from, e.g., UE 14. The RTSP describe request may include data indicating what types of data are supported by UE 14. UE 12 may respond to UE 14 with data indicating media streams that can be sent to UE 14, along with a corresponding network location identifier, such as a uniform resource locator (URL) or uniform resource name (URN).

UE 12 may then receive an RTSP setup request from UE 14. The RTSP setup request may generally indicate how a media stream is to be transported. The RTSP setup request may contain the network location identifier for the requested media data and a transport specifier, such as local ports for receiving RTP data and control data (e.g., RTCP data) on UE 14. UE 12 may reply to the RTSP setup request with a confirmation and data representing ports of UE 12 by which the RTP data and control data will be sent. UE 12 may then receive an RTSP play request, to cause the media stream to be “played,” i.e., sent to UE 14. UE 12 may also receive an RTSP teardown request to end the streaming session, in response to which, UE 12 may stop sending media data to UE 14 for the corresponding session.

UE 14, likewise, may initiate a media stream by initially sending an RTSP describe request to UE 12. The RTSP describe request may indicate types of data supported by UE 14. UE 14 may then receive a reply from UE 12 specifying available media streams that can be sent to UE 14, along with a corresponding network location identifier, such as a uniform resource locator (URL) or uniform resource name (URN).

UE 14 may then generate an RTSP setup request and send the RTSP setup request to UE 12. As noted above, the RTSP setup request may contain the network location identifier for the requested media data and a transport specifier, such as local ports for receiving RTP data and control data (e.g., RTCP data) on UE 14. In response, UE 14 may receive a confirmation from UE 12, including ports of UE 12 that UE 12 will use to send media data and control data.

After establishing a media streaming session (e.g., AR communication session 28) between UE 12 and UE 14, UE 12 exchange media data (e.g., packets of media data) with UE 14 according to the media streaming session. UE 12 and UE 14 may exchange control data (e.g., RTCP data) indicating, for example, reception statistics by UE 14, such that UEs 12, 14 can perform congestion control or otherwise diagnose and address transmission faults.

UEs 12, 14 and AR AS 22 may be configured to exchange compressed avatar blendshapes according to the techniques of this disclosure. For example, UE 12 may compress (encode) blendshapes for an avatar, and AR AS 22 and/or UE 14 may be configured to decode/decompress the blendshapes for the avatar. In particular, the blendshapes may be compressed in an avatar representation format. To compress the blendshapes, UE 12 may encode a transformation matrix, representing how to transform the base mesh to a blendshape associated with the transformation matrix. In particular, UE 12 may determine differences between vertices of the blendshape and corresponding vertices of the base mesh, normalize and quantize these difference values, then encode the quantized normalized values representing the differences between the vertices of the blendshape and the corresponding vertices of the base mesh. UE 12 may also encode indices for the vertices of the blendshape for which the quantized normalized values are coded. For example, UE 12 may avoid encoding a vertex for the blendshape if the difference between the vertex of the blendshape and the corresponding vertex of the base mesh does not exceed a threshold value. UE 12 may copy face connectivity information and texture coordinates as is from the base mesh. Other attributes, such as surface normal values, may be recomputed by the decoder, e.g., of AR AS 22 and/or UE 14. Such compression may result in significant reductions in base avatar model sizes, compared to sending each blendshape in an uncompressed state.

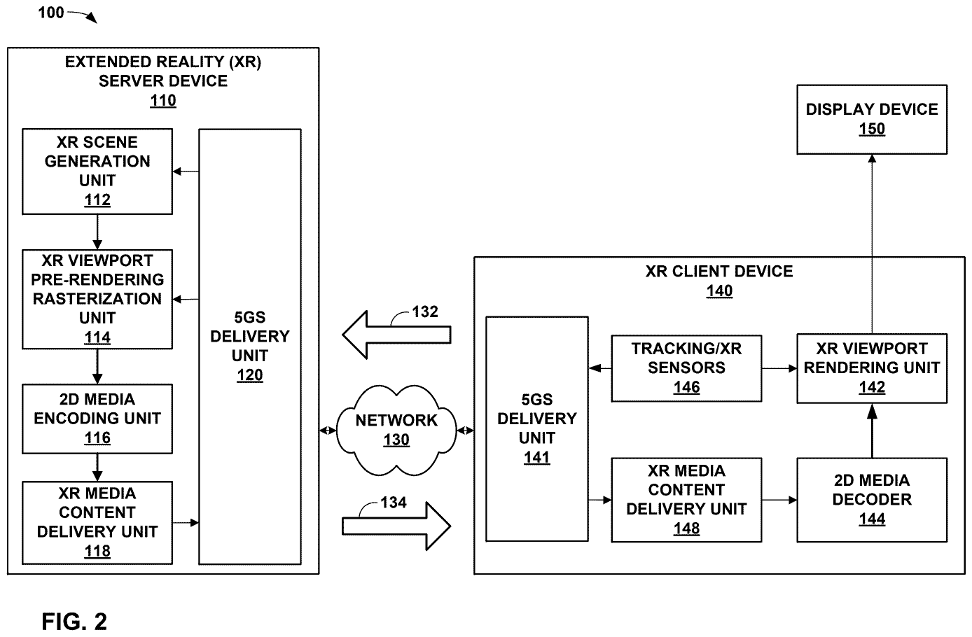

FIG. 2 is a block diagram illustrating an example computing system 100 that may perform split rendering techniques. In this example, computing system 100 includes extended reality (XR) server device 110, network 130, XR client device 140, and display device 150. XR server device 110 includes XR scene generation unit 112, XR viewport pre-rendering rasterization unit 114, 2D media encoding unit 116, XR media content delivery unit 118, and 5G System (5GS) delivery unit 120.

Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. For example, network 130 may represent a wireless or wired local network. In other examples, XR client device 140 and XR server device 110 may communicate via other mechanisms, such as Bluetooth, a wired universal serial bus (USB) connection, or the like. XR client device 140 includes 5GS delivery unit 141, tracking/XR sensors 146, XR viewport rendering unit 142, 2D media decoder 144, and XR media content delivery unit 148. XR client device 140 also interfaces with display device 150 to present XR media data to a user (not shown).

In some examples, XR scene generation unit 112 may correspond to an interactive media entertainment application, such as a video game, which may be executed by one or more processors implemented in circuitry of XR server device 110. XR viewport pre-rendering rasterization unit 114 may format scene data generated by XR scene generation unit 112 as pre-rendered two-dimensional (2D) media data (e.g., video data) for a viewport of a user of XR client device 140. 2D media encoding unit 116 may encode formatted scene data from XR viewport pre-rendering rasterization unit 114, e.g., using a video encoding standard, such as ITU-T H.264/Advanced Video Coding (AVC), ITU-T H.265/High Efficiency Video Coding (HEVC), ITU-T H.266 Versatile Video Coding (VVC), or the like. XR media content delivery unit 118 represents a content delivery sender, in this example. In this example, XR media content delivery unit 148 represents a content delivery receiver, and 2D media decoder 144 may perform error handling.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 141. XR client device 140 provides tracking and sensor information 132 to XR server device 110 via network 130. XR server device 110, in turn, receives tracking and sensor information 132 and provides this information to XR scene generation unit 112 and XR viewport pre-rendering rasterization unit 114. In this manner, XR scene generation unit 112 can generate scene data for the user's viewport and location, and then pre-render 2D media data for the user's viewport using XR viewport pre-rendering rasterization unit 114. XR server device 110 may therefore deliver encoded, pre-rendered 2D media data 134 to XR client device 140 via network 130, e.g., using a 5G radio configuration.

XR scene generation unit 112 may receive data representing a type of multimedia application (e.g., a type of video game), a state of the application, multiple user actions, or the like. XR viewport pre-rendering rasterization unit 114 may format a rasterized video signal. 2D media encoding unit 116 may be configured with a particular encoder/decoder (codec), bitrate for media encoding, a rate control algorithm and corresponding parameters, data for forming slices of pictures of the video data, low latency encoding parameters, error resilience parameters, intra-prediction parameters, or the like. XR media content delivery unit 118 may be configured with real-time transport protocol (RTP) parameters, rate control parameters, error resilience information, and the like. XR media content delivery unit 148 may be configured with feedback parameters, error concealment algorithms and parameters, post correction algorithms and parameters, and the like.

Raster-based split rendering refers to the case where XR server device 110 runs an XR engine (e.g., XR scene generation unit 112) to generate an XR scene based on information coming from an XR device, e.g., XR client device 140 and tracking and sensor information 132. XR server device 110 may rasterize an XR viewport and perform XR pre-rendering using XR viewport pre-rendering rasterization unit 114.

In the example of FIG. 2, the viewport is predominantly rendered in XR server device 110, but XR client device 140 is able to do latest pose correction, for example, using asynchronous time-warping or other XR pose correction to address changes in the pose. XR graphics workload may be split into rendering workload on a powerful XR server device 110 (in the cloud or the edge) and pose correction (such as asynchronous timewarp (ATW)) on XR client device 140. Low motion-to-photon latency is preserved via on-device Asynchronous Time Warping (ATW) or other pose correction methods performed by XR client device 140.

Furthermore, per techniques of this disclosure, XR viewport pre-rendering rasterization unit 114 may be configured to decode blendshapes of a base mesh for an avatar of another participant in an XR communication session. For example, XR viewport pre-rendering rasterization unit 114 may receive the base mesh and a set of blendshapes representing different potential animated facial expressions for the base mesh, for example. Encoded data for the blendshapes may include an encoded transformation matrix, including, for example, encoded quantized normalized values representing differences between vertices of the blendshape and corresponding vertices of the base mesh. The encoded data may further include indices for each of the vertices of the blendshape for which quantized normalized values have been encoded. XR viewport pre-rendering rasterization unit 114 may therefore reconstruct the blendshape by inverse quantizing and inverse normalizing the difference values indicated by the indices and reconstruct a mesh for the blendshape by offsetting vertices of the base mesh according to the reconstructed difference values. XR viewport pre-rendering rasterization unit 114 may copy vertices from the base mesh to the blendshape when there is no index value for that base mesh vertex (i.e., for vertices for which no difference value was encoded).

Thus, XR server device 110 may receive an animation stream from a device associated with the user to which the avatar base mesh corresponds. The animation stream may include, for example, a set of indices representing a blendshape to be animated or a set of multiple blendshapes to be combined through weighted combination for animation at a given time instance. XR viewport pre-rendering rasterization unit 114 may render the blendshape for the avatar of that user at the given time instance, then render an image from the perspective of a user of XR client device 140 for the avatar having the resulting blendshape.

The various components of XR server device 110, XR client device 140, and display device 150 may be implemented using one or more processors implemented in circuitry, such as one or more digital signal processors (DSPs), general purpose microprocessors, application specific integrated circuits (ASICs), field programmable logic arrays (FPGAs), or other equivalent integrated or discrete logic circuitry. The functions attributed to these various components may be implemented in hardware, software, or firmware. When implemented in software or firmware, it should be understood that instructions for the software or firmware may be stored on a computer-readable medium and executed by requisite hardware.

By performing the blendshape compression and decompression techniques within the split rendering architecture of computing system 100, computing system 100 may significantly reduce latency associated with initializing an AR communication session. Specifically, coding blendshapes as sparse deltas relative to a base mesh may avoid redundant transmission of static vertex data, thereby decreasing the file size of the base avatar model. This reduction may enable the XR media content delivery unit 118 to transmit the avatar data to a peer participant in the AR communication session more rapidly, minimizing the delay before a user can join and view the shared virtual space.

Furthermore, the employment of quantization and sparse indexing may improve memory usage on XR client device 140. Since extended reality devices often operate under strict power and memory constraints, storing compressed blendshapes alleviates hardware bottlenecks. This efficiency may ensure that XR viewport rendering unit 142 can dedicate resources to maintaining high frame rates and low motion-to-photon latency, which may facilitate an immersive user experience.

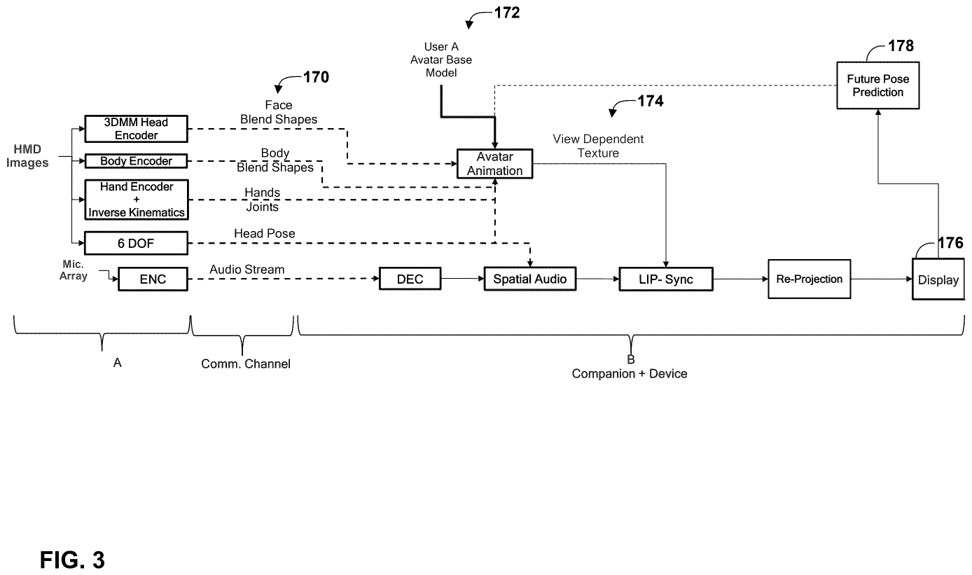

FIG. 3 is a flow diagram illustrating an example avatar animation workflow that may be used during an AR session. In this example, received animation stream data 170 includes face blendshapes, body blendshapes, hand joints, head pose, and audio stream data. The face blendshapes, body blendshapes, and hand joints may correspond to animation streams to be applied to user A avatar base model 172. In particular, data for user A avatar base model 172 may be stored at various levels of detail, per the techniques of this disclosure. Thus, processing system 174 may retrieve data of user A avatar base model 172 at an appropriate level of detail, e.g., based on a distance between a current user and user A in a 3D space.

User A avatar base model 172 may include a base mesh and a plurality of encoded blendshapes according to the techniques described herein. Processing system 174 on a user B UE device, including an avatar animation unit, a decoder (DEC), a spatial audio decoder, a lip synchronization unit, and a re-projection unit, as shown in FIG. 3, may decode each of the encoded blendshapes for user A avatar base model 172.

To decode each blendshape, processing system 174 may decode a transformation matrix of the blendshape. For example, processing system 174 may decode quantized normalized values representing differences between vertices of the blendshape and corresponding vertices of the base mesh. Processing system 174 may also decode indices for the vertices of the blendshape for which the quantized normalized values were encoded. Processing system 174 may further reconstruct each blendshape using the transformation matrix, differences between vertices of the blendshape and corresponding vertices of the base mesh, and the indices for the differences. Thus, an animation stream may be sent identifying one or more blendshapes to be blended together, and processing system 174 may use indications of the blendshapes to animate the base avatar mesh according to the animation stream during an AR communication session.

After having decoded each blendshape, processing system 174 may receive avatar animation data representing one or more blendshapes to be presented at a given time instance. Processing system 174 may then use the resulting mesh for the one or more blendshapes to render images of the corresponding avatar. Ultimately, processing system 174 may provide these images for display by display 176. In addition, movement data of the current user may be used to predict a future pose of the user by future pose prediction unit 178.

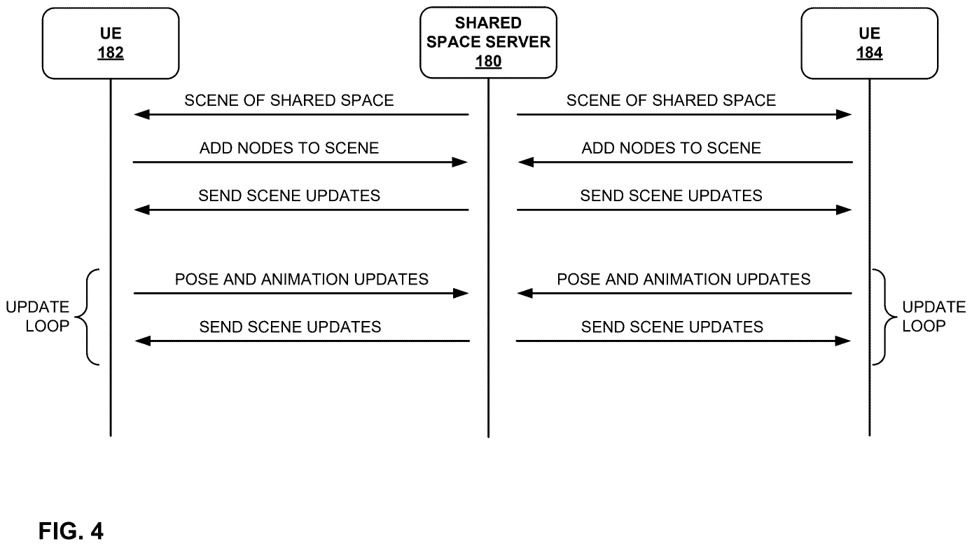

FIG. 4 is a flow diagram illustrating an example augmented reality (AR) session between two user equipment (UE) devices and a shared space server device. As shown in the example of FIG. 4, two or more UEs may participate in an AR session. The UEs may send and receive data representative of their animation streams and other 3D model data to and from a shared space server. For example, various sensors such as cameras, trackers, Light Detection and Ranging (LIDAR), or the like, may track user movements, such as facial movements (e.g., during speech or as emotional reactions), hand movements, walking movements, or the like. These movements may be translated into an animation stream by, e.g., UE 182 and sent to the shared space server.

Shared space server 180 may then send the animation stream to UE 184. UE 182 (acting as a sending device) may encode a blendshape for a base mesh of an avatar of AR media data to form an encoded blendshape. As discussed above, to encode a blendshape, UE 182 may encode a transformation matrix for the blendshape. UE 182 may encode quantized normalized values representing differences between vertices of the blendshape and corresponding vertices of the base mesh. UE 182 may encode indices for the vertices of the blendshape for which the quantized normalized values are encoded. UE 182 may send the base mesh and the encoded blendshape to shared space server 180 (acting as a receiving device) for the AR communication session. In examples where shared space server 180 comprises a digital asset repository, UE 182 may send access information to the digital asset repository granting access to the base mesh and the encoded blendshape to one or more participants in the AR communication session (e.g., UE 184).

Likewise, UE 184 may retrieve the base mesh and encoded blendshapes for the base mesh. UE 184 may decode each of the blendshapes as part of an initiation procedure for the AR communication session with UE 182. In some examples, UE 182 may send access credentials to UE 184 to access the base mesh and the encoded blendshapes. UE 184 may then receive data representing one or more blendshapes to be presented (e.g., directly or via weighted combination) at specific time instances as part of an animation stream included in scene updates. UE 184 may then render the corresponding blendshapes to form images to be presented to a user of UE 184.

UE 184 may simultaneously act as a sending device, and encode blendshapes for a base mesh using the same process described with respect to UE 182 above. Likewise, UE 182 may also, simultaneously, act as a receiving device and decode blendshapes of the base mesh corresponding to the user of UE 184.

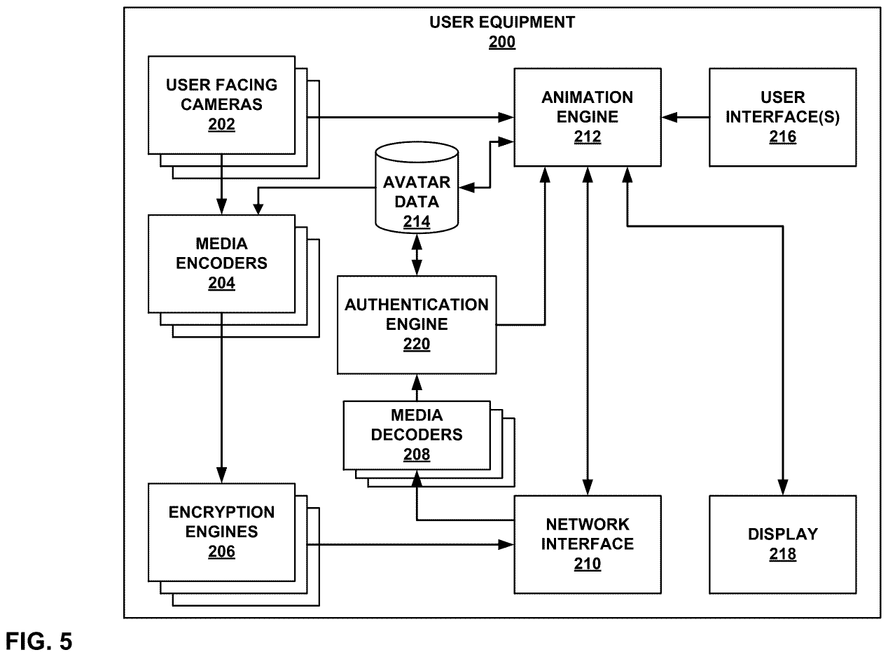

FIG. 5 is a block diagram illustrating an example user equipment (UE) 200. UEs 12, 14 of FIG. 1 may include components similar to those of UE 200. In general, a participant device may both send and receive content during an AR communication session. In this example, UE 200 includes user facing cameras 202, media encoders 204, encryption engines 206, media decoders 208, network interface 210, authentication engine 220, avatar data 214, animation engine 212, user interface(s) 216, and display 218.

A user may use UE 200 to participate in an AR communication session, e.g., to both send and receive AR data with one or more other participants in the AR communication session. For example, UE 200 may receive inputs from the user via user interface(s) 216, which may correspond to buttons, controllers, track pads, joysticks, keyboards, sensors, or the like. Such inputs may represent, for example, movements of the user in real-world space to be translated into the virtual scene, such as locomotive movement, head movements, eye movements (captured by user facing cameras 202), or interactions with the various buttons or other interface devices.

Animation engine 212 may receive such inputs and determine how to animate a user's avatar, stored in avatar data 214. For example, such animations may include locomotive animations (walking or running), arm movement animations, hand movement animations, finger movement animations, and/or facial expression change animations. Animation engine 212 may provide animation information to network interface 210 for output to other participants in the AR communication session, along with other information such as, for example, interactions with virtual objects, movement direction, viewport, or the like.

In addition, user facing cameras 202 may provide one or more video streams of a user's face to media encoder(s) 204 to form an encoded video stream, which may be encrypted by encryption engine(s) 206 or sent unencrypted. That is, one or more video streams capturing distinguishing features of the user's face or other objects of interest (e.g., background objects, location-identifying objects, unique identifiers, or the like) may be sent via network interface 210 to one or more other participants in the AR communication session. When the user is wearing a head-mounted display (HMD), the HMD may be configured to capture only parts of the user's face by user-facing cameras 202 of the HMD (e.g., eyes and mouth may be captured as three distinct streams). Such video streams (which may further be encrypted) may be provided to network interface 210 and sent to other participants in the AR communication session, such that the UEs of the other participants can authenticate that the avatar data is actually coming from the user of UE 200, per the techniques of this disclosure. In general, the distinguishing features may be any one or more elements of a person, location, object, or the like that may be used to uniquely identify the target person, location, or object and to associate the avatar (or other 3D object) with the target person, location, or object.

Similarly, UE 200 may receive encrypted video stream(s) from the other participants in the AR communication session. UE 200 may decrypt and then decode the video stream(s) using media decoders 208, which may provide the decrypted video streams to authentication engine 220. Authentication engine 220 may compare data of the received video streams to authentication data associated with an avatar of the other user being authenticated, stored with avatar data 214.

Per techniques of this disclosure, media encoders 204 may include video encoders, audio encoders, and mesh encoders. Thus, per techniques of this disclosure, media encoders 204 may be configured to encode/compress blendshapes associated with a base mesh of an avatar, e.g., stored in avatar data 214. Media encoders 204 may encode blendshapes for a base mesh of an avatar of AR media data to form a respective set of encoded blendshapes. To encode each blendshape, media encoders 204 may encode a transformation matrix for the blendshape. In particular, media encoders 204 may encode quantized normalized values representing differences between vertices of the blendshape and corresponding vertices of the base mesh. Media encoders 204 may also encode indices for the vertices of the blendshape for which the quantized normalized values are encoded. UE 200 may send the base mesh and each resulting encoded blendshape to a receiving device (e.g., via network interface 210) for an AR communication session. For example, UE 200 may send the base mesh and encoded blendshapes directly to another UE participating in the AR communication session, or to a digital asset repository.

Likewise, media decoders 208 may include video decoders, audio decoders, and mesh decoders. Thus, per techniques of this disclosure, media decoders 208 may be configured to decode/decompress blendshapes associated with a base mesh of an avatar received from a separate user and store the base mesh and blendshapes to avatar data 214. Media decoders 208 may receive a base mesh of an avatar of AR media data and a set of encoded blendshapes for the base mesh for another participant in the AR communication session. Media decoders 208 may decode the encoded blendshape to reproduce a blendshape that is decoded. Media decoders 208 may decode a transformation matrix for the blendshape. Media decoders 208 may decode quantized normalized difference values representing differences between vertices of the blendshape and corresponding vertices of the base mesh. Media decoders 208 may also decode indices for the vertices of the blendshape for which the quantized normalized values are encoded. To decode the quantized normalized difference values, media decoders 208 may inverse quantize the quantized normalized difference values for vertices of the blendshape, then inverse normalize the difference values. Ultimately, media decoders 208 may reconstruct the blendshape by offsetting vertices of the base mesh using corresponding indices for vertices of the blendshape (leaving vertices of the base mesh for which no indices were decoded in place).

Media decoders 208 may store the decoded blendshapes with avatar data 214. Animation engine 212 may then apply animation stream data to the base mesh and blendshapes of avatar data 214 to animate and render images for display via display 218.

In this manner, UE 200 may perform techniques for compressing/decompressing blendshapes of an avatar per techniques of this disclosure. Integrating the blendshape compression techniques into media encoders 204 may allow UE 200 to transmit complex avatar models with significantly reduced bandwidth requirements. By encoding blendshapes as quantized normalized differences relative to a base mesh, the system minimizes the data volume sent via network interface 210. This reduction in transmission size lowers the latency for other participants receiving the avatar data, thereby accelerating the initialization of the AR communication session and ensuring smoother real-time interaction.

Additionally, configuring media decoders 208 to decode compressed blendshapes may enable UE 200 to reconstruct high-fidelity avatar animations within the power and memory constraints of mobile hardware. Receiving the transformation matrix, quantized values, and sparse indices instead of full mesh data for each blendshape may reduce the computational load and storage footprint required to render the avatar, as well as reduce bandwidth consumed to initially begin an AR media communication session. This efficiency may permit animation engine 212 to maintain high frame rates and precise synchronization with user movements, which may enhance the immersive quality of the augmented reality experience.

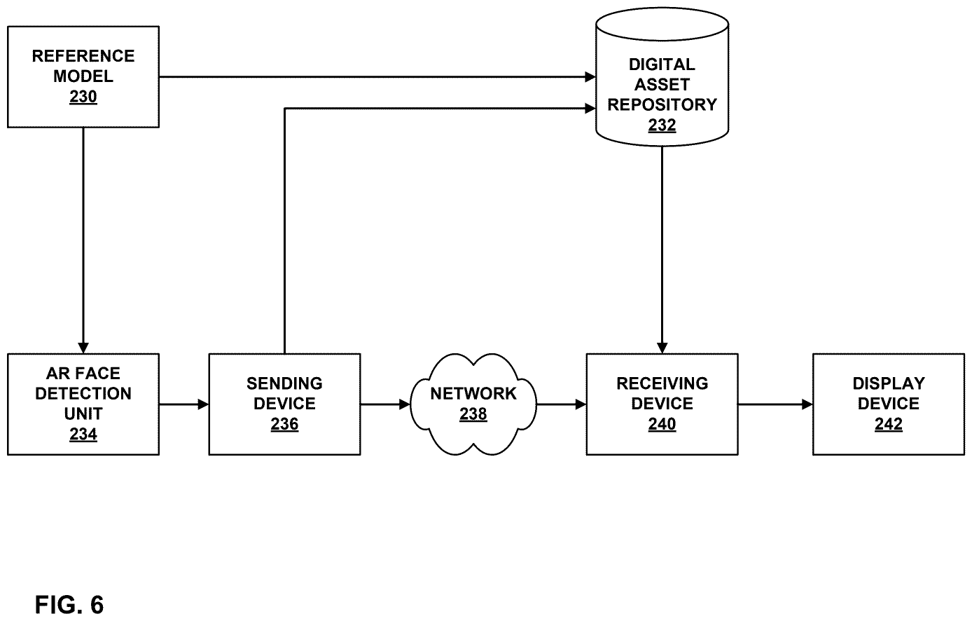

FIG. 6 is a block diagram illustrating an example set of devices that may perform various aspects of the techniques of this disclosure. The example of FIG. 6 depicts reference model 230, digital asset repository 232, AR face detection unit 234, sending device 236, network 238, receiving device 240, and display device 242. Sending device 236 may correspond to UE 12 of FIG. 1, and receiving device 240 may correspond to UE 14 of FIG. 1 and/or XR client device 140 of FIG. 2.

Sending device 236 and receiving device 240 may represent user equipment (UE) devices, such as smartphones, tablets, laptop computers, personal computers, or the like. Each of sending device 236 and receiving device 240 may include components similar to those of UE 200 of FIG. 5, e.g., for encoding, decoding, and storing base mesh and blendshape data, as well as an animation engine for rendering the base mesh and blendshape data for presentation to a user. AR face detection unit 234 may be included in an AR display device, such as an AR headset, which may be communicatively coupled to sending device 236. Likewise, display device 242 may be an AR display device, such as an AR headset.

In this example, reference model 230 includes model data for a human body and face. Digital asset repository 232 may include avatar data for a user, e.g., a user of sending device 236. Digital asset repository 232 may store the avatar data in a base avatar format. The base avatar format may differ based on software used to form the base avatar, e.g., modeling software from various vendors.

AR face detection unit 234 may detect facial expressions of a user and provide data representative of the facial expressions to sending device 236. Sending device 236 may encode the facial expression data and send the encoded facial expression data to receiving device 240 via network 238. Network 238 may represent the Internet or a private network (e.g., a virtual private network (VPN)). Receiving device 240 may decode and reconstruct the facial expression data and use the facial expression data to animate the avatar of the user of sending device 236.

Various facial and body tracking units may perform facial and body tracking in different ways, which may vary widely according to a solution being sought. For example, various facial and body tracking units may be configured with different numbers of blendshapes with different sets of expressions and/or different rigs (that is, 3D models of joints and bones) with different sets of bones and joints and different bone dimension. Some facial expressions and bones/joints do not exist in certain solutions but do exist in other solutions.

Blendshapes of avatars stored in digital asset repository 232 may be encoded/compressed according to techniques of this disclosure. Thus, receiving device 240 may include a decoder configured to decode/decompress the blendshapes. Sending device 236 may encode blendshapes for a base mesh of an avatar of AR media data to form an encoded blendshape.

In examples where sending device 236 sends a base mesh and encoded blendshapes to digital asset repository 232, sending device 236 may send access information to digital asset repository 232 granting access to the base mesh and the encoded blendshape to one or more participants in the AR communication session, such as receiving device 240. Thus, receiving device 240 may retrieve the base mesh of the avatar and the encoded blendshapes from digital asset repository 232. Receiving device 240 may decode the encoded blendshape to reproduce a decoded blendshape. To decode each blendshape, receiving device 240 may decode a transformation matrix, including decoding quantized normalized values representing differences between vertices of the blendshape and corresponding vertices of the base mesh. Receiving device 240 may also decode indices for the vertices of the blendshape for which the quantized normalized values are encoded.

In this manner, the various components of FIG. 6, per techniques of this disclosure, may alleviate network congestion and reduce the time required to initialize an augmented reality session between sending device 236 and receiving device 240. For example, by encoding the blendshapes as sparse, quantized differences relative to the base mesh, a total file size stored in digital asset repository 232 may be significantly lowered, compared to storing uncompressed blendshapes for every facial expression. This reduction may enable receiving device 240 to download the avatar assets more rapidly upon joining the session, thereby reducing startup delay and bandwidth consumption and providing a more responsive user experience.

Furthermore, the ability to decode these compressed blendshapes on receiving device 240 may allow for high-fidelity avatar animations without exceeding the storage or memory constraints of typical mobile or wearable hardware. Transmitting the encoded transformation matrix, quantized normalized values, and indices may ensure that digital asset repository 232 can distribute complex avatar models with numerous blendshapes while maintaining low bandwidth consumption. This configuration may ensure that visual quality remains high without consuming excess bandwidth for transmission of the blendshapes.

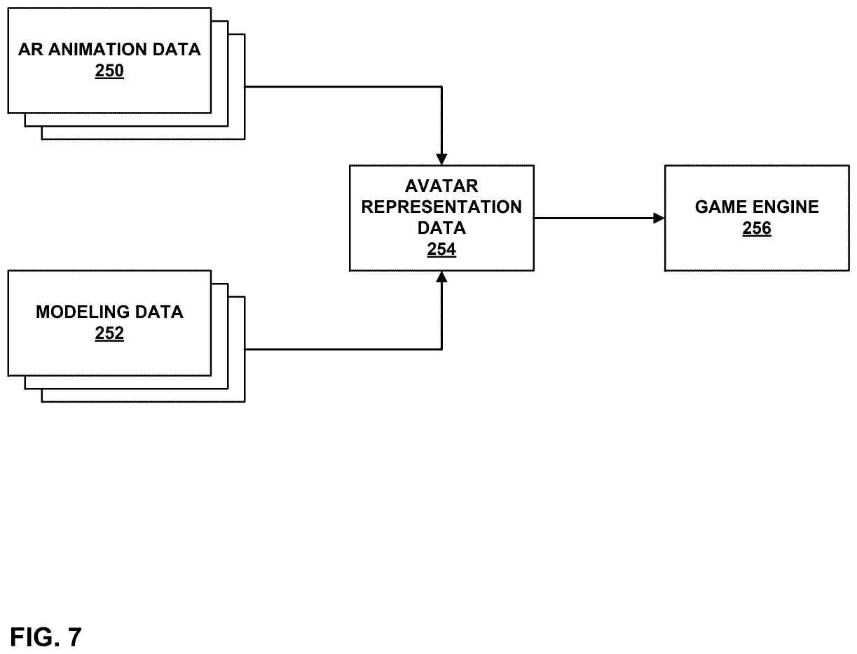

FIG. 7 is a conceptual diagram illustrating an example set of data that may be used in an AR session per techniques of this disclosure. In this example, FIG. 7 depicts AR animation data 250, modeling data 252, avatar representation data 254, and game engine 256. Modeling data 252 may represent one or more sets of data used to form a base avatar model, which may originate from various sources, such as modeling software (e.g., Blender or Maya), glTF, universal scene description (USD), VRM Consortium, MetaHuman, or the like. AR animation data 250 may represent one or more tracked movements of a user to be used to animate the base model, which may originate from OpenXR, ARKit, MediaPipe, or the like. The combination of the base model and the animation data may be formed into avatar representation data 254, which game engine 256 may use to display an animated avatar. Game engine 256 may represent Unreal Engine, Unity Engine, Godot Engine, a Third Generation Partnership Project (3GPP) engine, or the like.

A device (e.g., a sending device) may form avatar representation data 254 by encoding blendshapes for a base mesh of the avatar, per techniques of this disclosure. The device may encode a transformation matrix for each blendshape, including encoding quantized normalized values representing differences between vertices of the blendshape and corresponding vertices of the base mesh and indices for the vertices of the blendshape for which the quantized normalized values are encoded. Avatar representation data 254 may include the base mesh and the encoded blendshapes.

A media decoder (e.g., on a receiving device) may receive the base mesh and the encoded blendshape within avatar representation data 254. The media decoder may decode the encoded blendshapes to reproduce decoded blendshapes. The media decoder may decode the transformation matrix, the quantized normalized values, and the indices. To decode the quantized normalized values, the media decoder may inverse quantize the quantized normalized values for vertices of the blendshape, then inverse normalize the quantized normalized values. The media decoder may then use the decoded difference values and the indices to reconstruct the blendshape, e.g., by offsetting indicated vertices of the base mesh by the corresponding differences to positions for the blendshape.

Structuring avatar representation data 254 to include the compressed blendshapes may reduce the storage and transmission requirements for the avatar assets, relative to uncoded blendshapes. By containing the transformation matrix, indices, and quantized normalized values rather than full mesh geometries, the data structure minimizes the file size significantly relative to the original modeling data 252. This reduction may enable game engine 256 to load the necessary character models more rapidly, thereby decreasing the startup latency for the augmented reality experience.

Additionally, the format of avatar representation data 254 may facilitate efficient runtime processing by game engine 256. Decoding the sparse, quantized values allows game engine 256 to reconstruct the mesh deformations dynamically driven by AR animation data 250 without excessive computational overhead. This efficiency may ensure that the system maintains smooth animation frame rates even when processing complex avatars with numerous blendshapes on resource-constrained devices.

For example, a high-fidelity mesh for the avatar may comprise a large number of vertices defining, e.g., quads or triangles. To maintain a fluid user experience, the XR viewport rendering unit 142 may perform operations on these vertices at a rate of at least 30 frames per second. The compression techniques described herein may reduce the memory bandwidth required to fetch these vertices, thereby enabling XR client device 140 to meet these specific throughput requirements without stalling the rendering pipeline.

In some examples, the reconstruction of the avatar during the AR session involves storing the decoded deltas in memory accessible by a graphics processing unit (GPU). The rendering unit (e.g., game engine 256 or XR viewport rendering unit 142) may calculate the final vertex positions by applying the received animation weights to these stored deltas relative to the base mesh. To facilitate this rendering, XR client device 140 may store the decoded differences (deltas) for each blendshape in high-speed memory accessible by the GPU. During a rendering loop, XR viewport rendering unit 142 may calculate the final position of each vertex by accessing the static base mesh vertex and adding the weighted sum of the stored deltas corresponding to the active blendshapes. This approach may avoid the need to decode or reconstruct full mesh geometries for every frame, significantly reducing the computational operations per frame. This GPU-based approach may allow the system to process high-fidelity meshes (e.g., comprising 100,000 vertices or more) at real-time frame rates (e.g., 30 frames per second), which may result in fluid motion for the avatar.

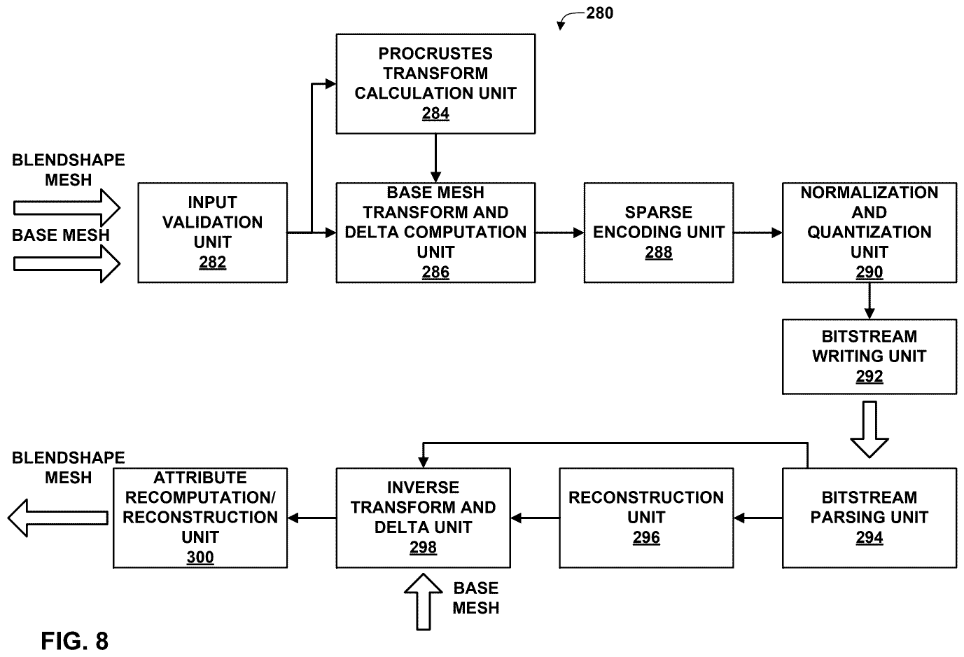

FIG. 8 is a block diagram illustrating an example system 280 that may be configured to perform the techniques of this disclosure. In particular, system 280 includes components for encoding and transmitting blendshapes, such as input validation unit 282, Procrustes transform calculation unit 284, base mesh transform and delta computation unit 286, sparse encoding unit 288, normalization and quantization unit 290, and bitstream writing unit 292, as well as components for receiving and decoding blendshapes, such as bitstream parsing unit 294, reconstruction unit 296, inverse transform and delta unit 298, and attribute recomputation/reconstruction unit 300. UEs 12 and 14 of FIG. 1, XR client device 140 of FIG. 2, UEs 182, 184 of FIG. 4, UE 200 of FIG. 5, and receiving device 240 of FIG. 6 may each include components similar to those of system 280 for encoding and sending or receiving and decoding blendshapes.

Input validation unit 282 may ensure that base and target blendshape meshes are compatible for processing and maintaining identical (or substantially identical) topology. Input validation unit 282 may generally receive the base mesh for an avatar and each blendshape mesh. To validate the blendshape, input validation unit 282 may perform a vertex and face count check to ensure that both meshes (the base mesh and the blendshape mesh) have the same number of vertices and faces. If this condition is not met, input validation unit 282 may interrupt the encoding process to avoid misalignment errors. Input validation unit 282 may also perform a face topology verification to ensure that face indices of the base and target (blendshape) meshes are identical. This may ensure that the connectivity and structure of the meshes remain unchanged through compression and reconstruction. Input validation unit 282 may report any mismatches and abort the compression process in the event of a mismatch of any of vertices, face count, or face topology.

Procrustes transform calculation unit 284 may perform a Procrustes transform (involving translation, rotation, and/or uniform scaling) to minimize positional differences between the base and target (blendshape) meshes. This Procrustes transform may result in alignment between the base mesh and the target mesh using a rigid transformation (scale, rotation, and translation). Initially, Procrustes transform calculation unit 284 may center the meshes, including computing a centroid (average position of all vertices) for both meshes. Procrustes transform calculation unit 284 may then subtract the centroid from all vertices to align both meshes at the origin. For example, Procrustes transform calculation unit 284 may calculate the centroid according to the following formula:

$$centroid = \frac{1}{N} {\sum }_{i = 1}^{N} {vertex}_{i}$$

Procrustes transform calculation unit 284 may also scale the vertices. That is, Procrustes transform calculation unit 284 may normalize the scale of the meshes, including computing the root mean square (RMS) distance of vertices from the centroid. Procrustes transform calculation unit 284 may further adjust the base mesh scale to match the target mesh. For example, Procrustes transform calculation unit 284 may calculate the scale according to the following formula:

$$scale = \frac{{blendshape}_{RMS}}{{base}_{RMS}}$$

Procrustes transform calculation unit 284 may also perform a rotation using a singular value decomposition (SVD). In particular, Procrustes transform calculation unit 284 may use the SVD on the covariance matrix H of the normalized meshes to compute the optimal rotation matrix R. Procrustes transform calculation unit 284 may ensure proper rotation by adjusting the determinant of R. For example, Procrustes transform calculation unit 284 may calculate R according to:

$$H = {base}_{normalized}^{T} \cdot {blendshape}_{normalized}$$

$$H = U \cdot \sum \cdot {V}^{T}$$

$$R = {V}^{T} \cdot {U}^{T}$$

$$if det ( R ) < 0 , flip sign of last column of R$$

Procrustes transform calculation unit 284 may also perform a translation. In particular, Procrustes transform calculation unit 284 may compute the translation vector to align the scaled and rotated base mesh with the target mesh.

Ultimately, Procrustes transform calculation unit 284 may construct a transformation matrix. That is, Procrustes transform calculation unit 284 may combine the scale, rotation, and translation into a 4×4 transformation matrix for efficient application.

Sparse encoding unit 288 may encode data representing significant changes in vertex positions between the base mesh and the target mesh. Sparse encoding unit 288 may perform a thresholding application. Sparse encoding unit 288 may identify vertices with significant positional deltas using a small threshold (e.g., 10⁻⁵). This may reduce or eliminate negligible changes, to further reduce bitrate consumed by the encoded blendshape.

This sparse encoding may be particularly advantageous for facial animation, where blendshapes often represent localized deformations (e.g., an eye blink or a mouth twitch) that affect only a small subset of the total vertices in the base mesh. By storing indices only for these specific regions, the sparse encoding unit 288 exploits the localized nature of facial expressions to better maximize compression efficiency relative to general mesh compression techniques.

Sparse encoding unit 288 may then perform index encoding. That is, sparse encoding unit 288 may store only the indices of vertices with significant deltas. Sparse encoding unit 288 may use relative indexing to optimize storage further by recording the difference between consecutive indices.

Sparse encoding unit 288 may then store values. In particular, sparse encoding unit 288 may store the positional deltas of significant vertices in a compact form. Sparse encoding unit 288 may store non-zero deltas as a separate array.

Sparse encoding unit 288 may also perform a sparsity analysis. For example, sparse encoding unit 288 may track the ratio of non-zero deltas to total vertices to determine the impact on compression efficiency.

Normalization and quantization unit 290 may scale deltas between vertices of the base mesh and corresponding vertices of the blendshape into a fixed range and reduce precision for efficient storage. To normalize the deltas, normalization and quantization unit 290 may compute the range (minimum and maximum) for each coordinate of the deltas. Normalization and quantization unit 290 may normalize the deltas to fit within a range, e.g., [−1, 1] on all dimensions. For example, normalization and quantization unit 290 may calculate a normalized value for each delta according to:

$$normalized\_value = \frac{value - min}{max - min}$$

Normalization and quantization unit 290 may then map the normalized values to integers using a specified bit depth (e.g., 8, 12, or 16 bits). Normalization and quantization unit 290 may also store quantization parameters (min, max, scale) for decompression. For example, normalization and quantization unit 290 may calculate quantized values according to:

$$quantized\_value = round ( normalized\_value * ( {2}^{bits} - 1 ) )$$

Bitstream writing unit 292 may generally efficiently package the compressed data and metadata for storage and/or transmission. Bitstream writing unit 292 may include information about the transformation matrix, quantization parameters, and sparse indices in a structured format as metadata for the blendshapes of the avatar. Bitstream writing unit 292 may serialize the metadata and sparse data into a binary stream. Bitstream writing unit 292 may concatenate the transformation matrix, sparse indices, and quantized or raw delta values. Bitstream writing unit 292 may then further encode the data using zlib or a similar Huffman entropy encoding algorithm to reduce the size of the binary stream. The compressed binary stream including the encoded blendshape data may be signaled using a compressor identifier, e.g., “urn:mpeg:compressor:avatar-blendshapes.”

Bitstream parsing unit 294 may generally perform a decoding process reciprocal to the encoding process performed by bitstream writing unit 292. Reconstruction unit 296 may reconstruct the normalized, quantized values. Inverse transform and delta unit 298 may apply the transform to the base mesh, then apply the deltas to the corresponding vertices of the transformed base mesh.

Attribute recomputation/reconstruction unit 300 may then reconstruct the blendshape mesh. In particular, attribute recomputation/reconstruction unit 300 may recompute vertex normals to achieve a smoother surface appearance after reconstruction. This has been found to improve performance over sending the normals in the compressed blendshape. To calculate face normals, attribute recomputation/reconstruction unit 300 may compute normals for each face using the cross-products of two edges. To calculate vertex normals, attribute recomputation/reconstruction unit 300 may calculate an average of the normals of all adjacent faces for each vertex and normalize these vectors to a unit length. Attribute recomputation/reconstruction unit 300 may then perform topology preservation by ensuring that the recomputed normals maintain the topology of the original mesh topology and visual fidelity.

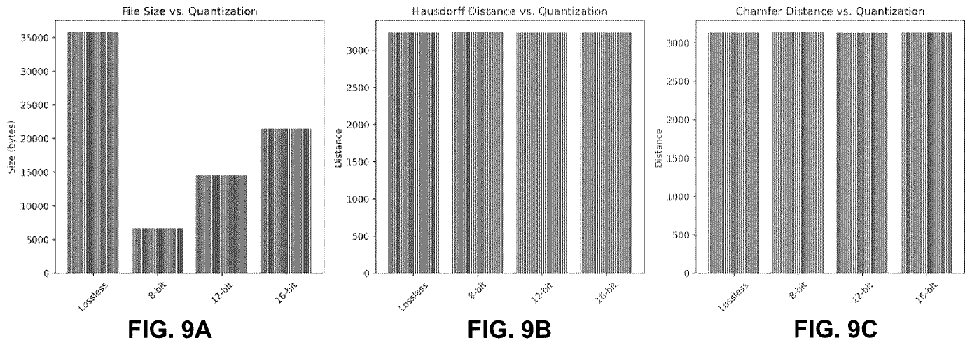

FIGS. 9A-9C are graphs depicting heuristic compression results for the techniques of this disclosure. FIG. 9A depicts sizes of files in bytes for lossless encoding, 8-bit quantization encoding, 12-bit quantization encoding, and 16-bit quantization encoding. FIG. 9B depicts Hausdorff distances between corresponding vertices of an original blendshape and a decoded blendshape for each of lossless, 8-bit, 12-bit, and 16-bit quantization. FIG. 9C depicts Chamfer distances representing the similarities between vertices of the original blendshape and the decoded blendshape for each of lossless, 8-bit, 12-bit, and 16-bit quantization. As shown in FIGS. 9A-9C, the encoding techniques of this disclosure may result in significant bitrate savings with minimal, if any, resulting distortion to the blendshape as a result of encoding and decoding.

The results in FIGS. 9A-9C demonstrate performance metrics associated with coding quantized normalized values representing differences between vertices of the blendshape and corresponding vertices of the base mesh. The 8-bit, 12-bit, and 16-bit quantization encoding shown in FIG. 9A corresponds to examples where the specified bit depth comprises one of 8 bits, 12 bits, or 16 bits, compared with lossless encoding. A system encoding the blendshape may determine the quantized values based on a normalization of the differences to fit within a range of values for each dimension. The system may then quantize the normalized values to the quantized values having the specified bit depth. FIG. 9A illustrates that using the specified bit depth (e.g., 8, 12, or 16 bits) reduces file size compared to lossless encoding. FIGS. 9B and 9C illustrate that the system maintains low distortion when decoding the quantized normalized values to reproduce the blendshape.

As demonstrated in FIGS. 9A-9C, the techniques of this disclosure may achieve a substantial reduction in the data size required to represent the blendshapes of the avatar. Since the base avatar model (including the base mesh and all associated blendshapes) is typically downloaded at the initiation of an AR communication session, this reduction in file size may directly translate to reduced startup latency. The user can join and interact within the shared virtual space more quickly compared to systems that transmit uncompressed blendshape meshes.

Furthermore, the results in FIGS. 9B and 9C indicate that this reduction in size, achieved through normalizing differences and quantizing the differences to a specific bit depth, does not significantly compromise the visual fidelity of the avatar. The low error distances confirm that the reconstructed blendshapes remain visually accurate to the original models. Consequently, the techniques of this disclosure may provide an efficient balance between bandwidth/storage requirements and visual quality, enabling high-fidelity avatar animations even under constrained network conditions or on devices with limited memory resources.

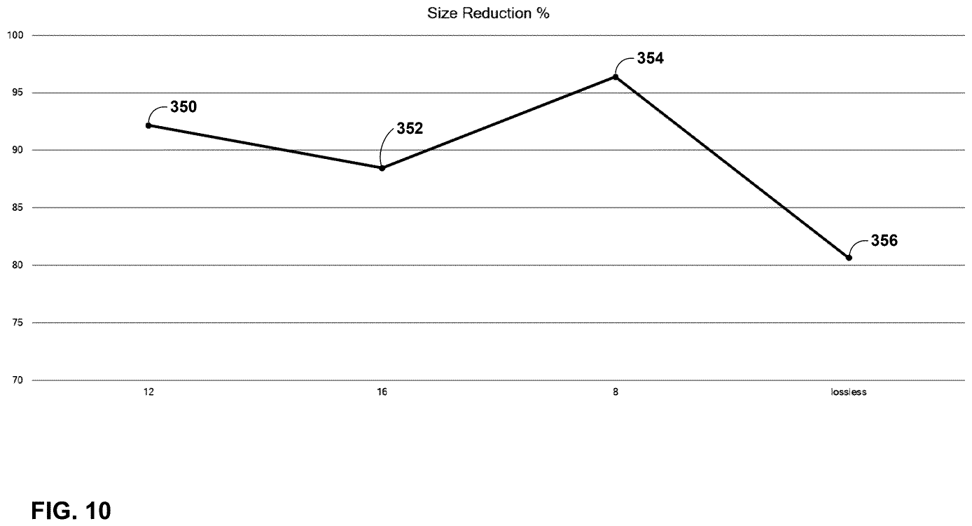

FIG. 10 is a graph depicting percentage file size reduction by quantization amount using the techniques of this disclosure. The graph depicts example heuristic testing results of the techniques of this disclosure. The graph includes 12-bit quantization results 350, 16-bit quantization results 352, 8-bit quantization results 354, and lossless results 356. The vertical axis represents a percentage of file size reduction relative to an uncompressed original file size of blendshapes for an avatar base model. The horizontal axis represents a quantization bit depth or mode utilized by an encoding device to compress the blendshapes of the avatar base model.

8-bit quantization results 354 indicate a size reduction of approximately 96 percent. 12-bit quantization results 350 indicate a size reduction of approximately 93 percent. 16-bit quantization results 352 indicate a size reduction of approximately 88 percent. Lossless results 356 indicate a size reduction of approximately 80 percent. Lossless results 356 demonstrate that the sparse encoding and bitstream structuring techniques of this disclosure provide significant compression (approximately 80 percent), even without applying quantization to the difference values. Applying quantization further increases the file size reduction. For example, the system may select 8-bit quantization to maximize compression for low-bandwidth environments, or select 16-bit quantization to retain higher precision for the vertex deltas while still achieving substantial storage savings. The results illustrate that the described techniques allow for a configurable trade-off between visual fidelity and data size efficiency.

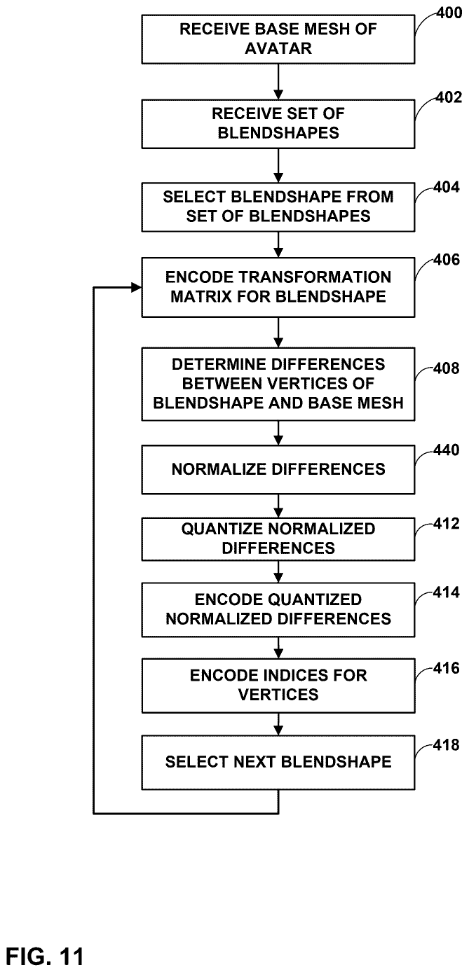

FIG. 11 is a flowchart illustrating an example method of encoding blendshapes per the techniques of this disclosure. The method of FIG. 11 is described with respect to sending device 236 of FIG. 6. However, other devices, such as UE 12 or UE 14 of FIG. 1, XR server device 110 of FIG. 2, processing system 174 of FIG. 3, UEs 182, 184 of FIG. 4, UE 200 of FIG. 5, or the encoding components of FIG. 8 may also perform the method of FIG. 11.

Initially, sending device 236 may receive a base mesh of an avatar (400) and receive a set of blendshapes for the avatar (402). Prior to encoding the blendshapes, sending device 236 may perform validation checks. Sending device 236 may determine a number of vertices in the base mesh and a number of vertices in a blendshape. Sending device 236 may encode the blendshape after determining that the number of vertices in the blendshape is equal to the number of vertices in the base mesh. Sending device 236 may determine a number of faces in the base mesh and a number of faces in the blendshape. Sending device 236 may encode the blendshape after determining that the number of faces in the blendshape is equal to the number of faces in the base mesh. Sending device 236 may determine indices for faces of the base mesh and indices for faces of the blendshape. Sending device 236 may encode the blendshape after determining that the indices for the faces of the base mesh match the indices for the faces of the blendshape.

Sending device 236 may select a blendshape from the set of blendshapes (404) and encode a transformation matrix for the blendshape (406). Sending device 236 may first calculate the transformation matrix. Calculating the transformation matrix may include calculating a centroid for the base mesh, calculating a centroid for the blendshape, and calculating a vector to align the centroid for the base mesh with the centroid for the blendshape. Sending device 236 may calculate the centroid for the base mesh by averaging the positions of the N vertices of the base mesh. Calculating the transformation matrix may further include calculating a scale value for scaling vertices of the blendshape to vertices of the base mesh. Sending device 236 may calculate the scale value based on a ratio of a root mean square (RMS) distance of vertices from the centroid for the blendshape to an RMS distance of vertices from the centroid for the base mesh. Calculating the transformation matrix may also include calculating a rotation to rotate the blendshape to match a rotation of the base mesh. Sending device 236 may calculate a 4×4 transformation matrix combining the translation, scale, and rotation.

Sending device 236 may determine differences between vertices of the blendshape and the base mesh (408). Sending device 236 may calculate the differences between positions of vertices of the blendshape and vertices of the base mesh. Sending device 236 may encode difference values for the vertices of the blendshape when the vertices have differences greater than a threshold value (e.g., 10⁻⁵). Sending device 236 may normalize the differences (440). Sending device 236 may determine minimum values and maximum values for coordinates of the differences. Sending device 236 may calculate normalized values that normalize the differences to fit within a range of values for each dimension (e.g., based on the range defined by the minimum and maximum values).

Sending device 236 may quantize the normalized differences (412). Sending device 236 may quantize the normalized values to quantized values having a specified bit depth. The specified bit depth may be one of 8 bits, 12 bits, or 16 bits, or other bit depths. Sending device 236 may encode the quantized normalized differences (414). Sending device 236 may encode the quantized normalized values representing differences between vertices of the blendshape and corresponding vertices of the base mesh. Sending device 236 may encode indices for the vertices (416) for which the quantized normalized values are encoded. Sending device 236 may entropy encode parameters for the blendshape, such as the transformation matrix, the quantized normalized values, and the indices. Sending device 236 may entropy encode the parameters using zlib or a Huffman entropy encoding algorithm, or other entropy encoding techniques. Sending device 236 may select a next blendshape (418) and repeat the process until all blendshapes in the set are encoded.

Sending device 236 may then send the base mesh and the encoded blendshape(s) to a receiving device for an AR communication session. The receiving device may be a device of another participant in the AR communication session and/or a digital asset repository, e.g., digital asset repository 232 of FIG. 6. Sending device 236 may further send access credentials to the digital asset repository granting access to other participants in the AR communication session to the base mesh and encoded blendshapes. Sending device 236 may then send an animation stream to the other participants in the AR communication session indicating one or more blendshapes to be animated and rendered for each time instance of the AR communication session.

In this manner, the method of FIG. 11 represents an example of a method of communicating AR media data, including: encoding a blendshape for a base mesh of an avatar of AR media data to form an encoded blendshape, including: encoding a transformation matrix; encoding quantized normalized values representing differences between vertices of the blendshape and corresponding vertices of the base mesh; and encoding indices for the vertices of the blendshape for which the quantized normalized values are encoded, and sending the base mesh and the encoded blendshape to a receiving device for an AR communication session.

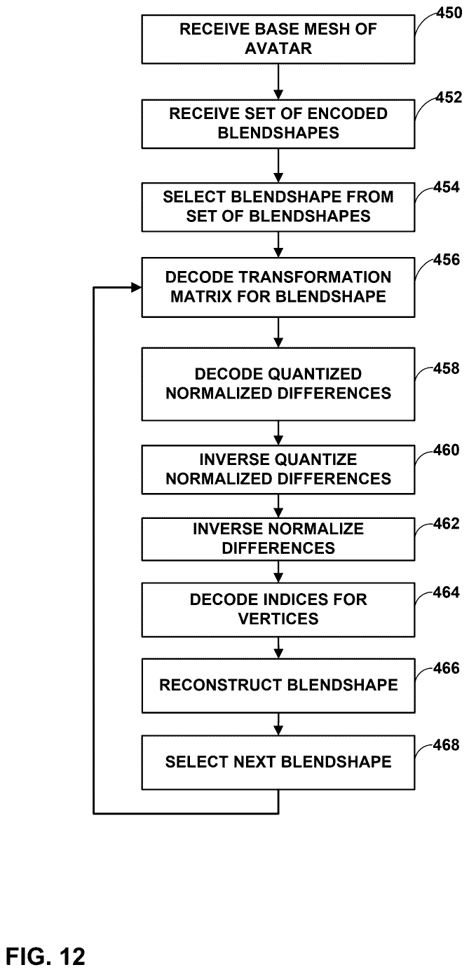

FIG. 12 is a flowchart illustrating an example method of decoding blendshapes per the techniques of this disclosure. The method of FIG. 12 is explained with respect to receiving device 240 for purposes of example. However, other devices, such as UEs 12, 14 of FIG. 1, XR server device 110 of FIG. 2, the encoding components of FIG. 3, UEs 182, 184 of FIG. 4, UE 200 of FIG. 5, or the encoding components of FIG. 8 may also perform this or a similar method.

Initially, receiving device 240 may receive a base mesh of an avatar of AR media data (450). Receiving device 240 may also receive a set of encoded blendshapes for the base mesh for an AR communication session (452).

Receiving device 240 may select a blendshape from the set of encoded blendshapes (454). Receiving device 240 may decode the encoded blendshape to reproduce a blendshape that is decoded. To decode the blendshape, receiving device 240 may decode a transformation matrix for the blendshape (456). Receiving device 240 may decode quantized normalized values representing differences between vertices of the blendshape and corresponding vertices of the base mesh (458). Receiving device 240 may inverse quantize the normalized differences (460). Receiving device 240 may inverse quantize the quantized normalized values for vertices of the blendshape to obtain normalized values. Receiving device 240 may inverse normalize the differences (462). Receiving device 240 may map the normalized values back to an original coordinate range using quantization parameters (e.g., min, max, scale) received in a bitstream.

Receiving device 240 may decode indices for vertices (464). Receiving device 240 may decode indices for the vertices of the blendshape for which the quantized normalized values are encoded. Receiving device 240 may reconstruct the blendshape (466). Receiving device 240 may apply the transformation matrix to the base mesh and apply the differences to the corresponding vertices of the transformed base mesh identified by the indices. Receiving device 240 may recalculate vertex normals for the blendshape. Recalculating the vertex normals may include computing face normals for faces of the blendshape and, for each vertex of the blendshape, averaging the face normals for each of the faces that are adjacent to the vertex.

Receiving device 240 may select a next blendshape (468) and repeat the decoding process until all blendshapes in the set are decoded. Receiving device 240 may use the decoded blendshapes for rendering. Receiving device 240 may join the AR communication session having a participant corresponding to the avatar. Receiving device 240 may receive, via the AR communication session, data indicating that the blendshape is to be presented for the participant (e.g., an animation stream with weights for each blendshape to be presented at a given time instance). Receiving device 240 may then render the resulting blendshape in response to receiving the data indicating that the blendshape is to be presented.

In this manner, the method of FIG. 12 represents an example of a method including: receiving a base mesh of an avatar of AR media data and an encoded blendshape for the base mesh for an AR communication session; and decoding the encoded blendshape to reproduce a blendshape that is decoded, including: decoding a transformation matrix; decoding quantized normalized values representing differences between vertices of the blendshape and corresponding vertices of the base mesh; and decoding indices for the vertices of the blendshape for which the quantized normalized values are encoded.

Various examples of the techniques of this disclosure are summarized in the following clauses:
Clause 1: A method of communicating augmented reality (AR) media data, the method comprising: coding a blendshape for a base mesh of an avatar of AR media data, including: coding a transformation matrix; coding quantized normalized values representing differences between vertices of the blendshape and corresponding vertices of the base mesh; and coding indices for the vertices of the blendshape for which the quantized normalized values are coded.
Clause 2: The method of clause 1, wherein coding comprises encoding.
Clause 3: The method of clause 2, further comprising, prior to encoding the blendshape: determining a number of vertices in the base mesh; determining a number of vertices in the blendshape; and encoding the blendshape after determining that the number of vertices in the blendshape is equal to the number of vertices in the base mesh.
Clause 4: The method of any of clauses 2 and 3, further comprising, prior to encoding the blendshape: determining a number of faces in the base mesh; determining a number of faces in the blendshape; and encoding the blendshape after determining that the number of faces in the blendshape is equal to the number of faces in the base mesh.
Clause 5: The method of any of clauses 2-4, further comprising, prior to encoding the blendshape: determining indices for faces of the base mesh; determining indices for faces of the blendshape; and encoding the blendshape after determining that the indices for the faces of the base mesh match the indices for the faces of the blendshape.
Clause 6: The method of any of clauses 2-5, further comprising calculating the transform matrix.
Clause 7: The method of clause 6, wherein calculating the transform matrix includes: calculating a centroid for the base mesh; calculating a centroid for the blendshape; and calculating a vector to align the centroid for the base mesh with the centroid for the blendshape.
Clause 8: The method of clause 7, wherein calculating the centroid includes, for each of N vertices, calculating the centroid according to:

$$centroid = \frac{1}{N} {\sum }_{i = 1}^{N} {vertex}_{i} .$$

Clause 9: The method of any of clauses 6-8, wherein calculating the transform matrix includes calculating a scale value for scaling vertices of the blendshape to vertices of the base mesh according to:

$$scale = \frac{{blendshape}_{RMS}}{{base}_{RMS}} .$$

Clause 10: The method of any of clauses 6-9, wherein calculating the transform matrix includes calculating a rotation to rotate the blendshape to match a rotation of the base mesh.
Clause 11: The method of any of clauses 6-10, wherein calculating the transform matrix comprises calculating a 4×4 transformation matrix.
Clause 12: The method of any of clauses 2-11, wherein encoding the blendshape includes: calculating differences between positions of vertices of the blendshape and vertices of the base meshes; and encoding difference values for the vertices of the blendshape when the vertices have differences greater than a threshold value.
Clause 13: The method of clause 12, wherein the threshold value comprises 10⁻⁵.
Clause 14: The method of any of clauses 2-13, wherein encoding the blendshape includes: calculating differences between positions of vertices of the blendshape and vertices of the base meshes; determining minimum values and maximum values for coordinates of the differences; and calculating normalized values that normalize the differences to fit within a range of values for each dimension according to:

$$normalized\_value = \frac{value - min}{max - min} .$$

Clause 15: The method of clause 14, further comprising quantizing the normalized values to quantized values having a specified bit depth according to:

$$quantized\_value = round ( normalized\_value * ( {2}^{bits} - 1 ) ) .$$

Clause 16: The method of clause 15, wherein the specified bit depth comprises one of 8 bits, 12 bits, or 16 bits.
Clause 17: The method of any of clauses 2-16, wherein encoding the blendshape further comprises entropy encoding parameters for the blendshape.
Clause 18: The method of clause 17, wherein entropy encoding the parameters comprises entropy encoding the parameters using zlib or a Huffman entropy encoding algorithm.
Clause 19: The method of clause 1, wherein coding comprises decoding.
Clause 20: The method of clause 19, wherein decoding comprises inverse quantizing normalized difference values for vertices of the blendshape.
Clause 21: The method of any of clauses 19 and 20, further comprising recalculating vertex normals for the blendshape.
Clause 22: The method of clause 21, wherein recalculating the vertex normals includes: computing face normals for faces of the blendshape; and for each vertex of the blendshape, averaging the face normals for each of the faces that are adjacent to the vertex.
Clause 23: The method of any of clauses 19-22, further comprising: joining an AR communication session having a participant corresponding to the avatar; receiving, via the AR communication session, data indicating that the blendshape is to be presented for the participant; and presenting the blendshape in response to receiving the data indicating that the blendshape is to be presented.
Clause 24: A method of storing augmented reality (AR) data related to a three-dimensional (3D) avatar for a user, the method comprising: compressing a set of blendshape meshes for facial animations of an avatar using a base mesh of the avatar; and storing the compressed set of blendshape meshes, the base mesh, and metadata indicating how to decode and reconstruct the blendshape meshes.
Clause 25: A device for processing augmented reality (AR) media data, the device comprising one or more means for performing the method of any of clauses 1-24.
Clause 26: The device of clause 25, wherein the one or more means comprise a processing system implemented in circuitry and a memory configured to store AR media data.
Clause 27: A device for communicating augmented reality (AR) media data, the device comprising: means for coding a blendshape for a base mesh of an avatar of AR media data, including: means for coding a transformation matrix; means for coding quantized normalized values representing differences between vertices of the blendshape and corresponding vertices of the base mesh; and means for coding indices for the vertices of the blendshape for which the quantized normalized values are coded.
Clause 28: A device for storing augmented reality (AR) media data related to a three-dimensional (3D) avatar for a user, the device comprising: means for compressing a set of blendshape meshes for facial animations of an avatar using a base mesh of the avatar; and means for storing the compressed set of blendshape meshes, the base mesh, and metadata indicating how to decode and reconstruct the blendshape meshes.
Clause 29: A method of communicating augmented reality (AR) media data, the method comprising: encoding a blendshape for a base mesh of an avatar of AR media data to form an encoded blendshape, including: encoding a transformation matrix; encoding quantized normalized values representing differences between vertices of the blendshape and corresponding vertices of the base mesh; and encoding indices for the vertices of the blendshape for which the quantized normalized values are encoded, and sending the base mesh and the encoded blendshape to a receiving device for an AR communication session.
Clause 30: The method of clause 29, wherein the receiving device comprises a digital asset repository, the method further comprising sending access information to the digital asset repository granting access to the base mesh and the encoded blendshape to one or more participants in the AR communication session.
Clause 31: The method of any of clauses 29 and 30, further comprising, prior to encoding the blendshape: determining a number of vertices in the base mesh;
determining a number of vertices in the blendshape; and encoding the blendshape after determining that the number of vertices in the blendshape is equal to the number of vertices in the base mesh.
Clause 32: The method of any of clauses 29-31, further comprising, prior to encoding the blendshape: determining a number of faces in the base mesh; determining a number of faces in the blendshape; and encoding the blendshape after determining that the number of faces in the blendshape is equal to the number of faces in the base mesh.
Clause 33: The method of any of clauses 29-32, further comprising, prior to encoding the blendshape: determining indices for faces of the base mesh; determining indices for faces of the blendshape; and encoding the blendshape after determining that the indices for the faces of the base mesh match the indices for the faces of the blendshape.
Clause 34: The method of any of clauses 29-33, further comprising calculating the transformation matrix.
Clause 35: The method of clause 34, wherein calculating the transformation matrix includes: calculating a centroid for the base mesh; calculating a centroid for the blendshape; and calculating a vector to align the centroid for the base mesh with the centroid for the blendshape.
Clause 36: The method of clause 35, wherein calculating the centroid for the base mesh includes, for each of N vertices of the base mesh, calculating the centroid according to:

$$centroid = \frac{1}{N} {\sum }_{i = 1}^{N} {vertex}_{i} .$$

Clause 37: The method of any of clauses 34-36, wherein calculating the transformation matrix includes calculating a scale value for scaling vertices of the blendshape to vertices of the base mesh according to:

$$scale = \frac{{blendshape}_{RMS}}{{base}_{RMS}} .$$

Clause 38: The method of any of clauses 34-37, wherein calculating the transformation matrix includes calculating a rotation to rotate the blendshape to match a rotation of the base mesh.
Clause 39: The method of any of clauses 34-38, wherein calculating the transformation matrix comprises calculating a 4×4 transformation matrix.
Clause 40: The method of any of clauses 29-39, wherein encoding the blendshape includes: calculating differences between positions of vertices of the blendshape and vertices of the base mesh; and encoding difference values for the vertices of the blendshape when the vertices have differences greater than a threshold value.
Clause 41: The method of clause 40, wherein the threshold value comprises 10⁻⁵.
Clause 42: The method of any of clauses 29-41, wherein encoding the blendshape includes: calculating differences between positions of vertices of the blendshape and vertices of the base mesh; determining minimum values and maximum values for coordinates of the differences; and calculating normalized values that normalize the differences to fit within a range of values for each dimension according to:

$$normalized\_value = \frac{value - min}{max - min} .$$

Clause 43: The method of clause 42, further comprising quantizing the normalized values to quantized values having a specified bit depth according to:

$$quantized\_value = round ( normalized\_value * ( {2}^{bits} - 1 ) ) .$$

Clause 44: The method of clause 43, wherein the specified bit depth comprises one of 8 bits, 12 bits, or 16 bits.
Clause 45: The method of any of clauses 29-44, wherein encoding the blendshape further comprises entropy encoding parameters for the blendshape.
Clause 46: The method of clause 45, wherein entropy encoding the parameters comprises entropy encoding the parameters using one of zlib or a Huffman entropy encoding algorithm.
Clause 47: A device for communicating augmented reality (AR) media data, the device comprising: a memory configured to store AR media data; and a processing system implemented in circuitry and configured to: encode a blendshape for a base mesh of an avatar of the AR media data to form an encoded blendshape, wherein to encode the blendshape, the processing system is configured to: encode a transformation matrix; encode quantized normalized values representing differences between vertices of the blendshape and corresponding vertices of the base mesh; and encode indices for the vertices of the blendshape for which the quantized normalized values are encoded, and sending the base mesh and the encoded blendshape to a receiving device for an AR communication session.
Clause 48: The device of clause 47, wherein the receiving device comprises a digital asset repository, and wherein the processing system is further configured to send access information to the digital asset repository granting access to the base mesh and the encoded blendshape to one or more participants in the AR communication session.
Clause 49: The device of any of clauses 47 and 48, wherein the processing system is further configured to calculate a transformation matrix, including: calculate a centroid for the base mesh; calculate a centroid for the blendshape; and calculate a vector to align the centroid for the base mesh with the centroid for the blendshape.
Clause 50: The device of any of clauses 47-49, wherein to encode the blendshape, the processing system is further configured to: calculate differences between positions of vertices of the blendshape and vertices of the base mesh; and encode difference values for the vertices of the blendshape when the vertices have differences greater than a threshold value.
Clause 51: A method of communicating augmented reality (AR) media data, the method comprising: receiving a base mesh of an avatar of AR media data and an encoded blendshape for the base mesh for an AR communication session; and decoding the encoded blendshape to reproduce a blendshape that is decoded, including: decoding a transformation matrix; decoding quantized normalized values representing differences between vertices of the blendshape and corresponding vertices of the base mesh; and decoding indices for the vertices of the blendshape for which the quantized normalized values are encoded.
Clause 52: The method of clause 51, wherein decoding the quantized normalized values comprises inverse quantizing the quantized normalized values for vertices of the blendshape.
Clause 53: The method of any of clauses 51 and 52, further comprising recalculating vertex normals for the blendshape.
Clause 54: The method of clause 53, wherein recalculating the vertex normals includes: computing face normals for faces of the blendshape; and for each vertex of the blendshape, averaging the face normals for each of the faces that are adjacent to the vertex.
Clause 55: The method of any of clauses 51-54, further comprising: joining the AR communication session having a participant corresponding to the avatar; receiving, via the AR communication session, data indicating that the blendshape is to be presented for the participant; and presenting the blendshape in response to receiving the data indicating that the blendshape is to be presented.
Clause 56: A device for communicating augmented reality (AR) media data, the device comprising: a memory configured to store AR media data; and a processing system implemented in circuitry and configured to: receive a base mesh of an avatar of AR media data and an encoded blendshape for the base mesh for an AR communication session; and decode the encoded blendshape to reproduce a blendshape that is decoded, including: decode a transformation matrix; decode quantized normalized values representing differences between vertices of the blendshape and corresponding vertices of the base mesh; and decode indices for the vertices of the blendshape for which the quantized normalized values are encoded.
Clause 57: The device of clause 56, wherein to decode the quantized normalized values, the processing system is configured to inverse quantize the quantized normalized values for vertices of the blendshape.
Clause 58: The device of any of clauses 56 and 57, wherein the processing system is further configured to: join the AR communication session having a participant corresponding to the avatar; receive, via the AR communication session, data indicating that the blendshape is to be presented for the participant; and present the blendshape in response to receiving the data indicating that the blendshape is to be presented.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of communicating augmented reality (AR) media data, the method comprising:
encoding a blendshape relative to a base mesh of an avatar of AR media data to form an encoded blendshape;
storing the encoded blendshape to an avatar representation format data structure; and
sending the base mesh and the avatar representation format data structure including the encoded blendshape to a receiving device for an AR communication session.

2. The method of claim 1, wherein the receiving device comprises a digital asset repository, the method further comprising sending access information to the digital asset repository granting access to the base mesh and the encoded blendshape to one or more participants in the AR communication session.

3. The method of claim 1, further comprising, prior to encoding the blendshape:
determining a number of vertices in the base mesh;
determining a number of vertices in the blendshape; and
encoding the blendshape after determining that the number of vertices in the blendshape is equal to the number of vertices in the base mesh.

4. The method of claim 1, further comprising, prior to encoding the blendshape:
determining a number of faces in the base mesh;
determining a number of faces in the blendshape; and
encoding the blendshape after determining that the number of faces in the blendshape is equal to the number of faces in the base mesh.

5. The method of claim 1, further comprising, prior to encoding the blendshape:
determining indices for faces of the base mesh;
determining indices for faces of the blendshape; and
encoding the blendshape after determining that the indices for the faces of the base mesh match the indices for the faces of the blendshape.

6. The method of claim 1, wherein encoding the blendshape includes:
encoding a transformation matrix;
encoding quantized normalized values representing differences between vertices of the blendshape and corresponding vertices of the base mesh; and
encoding indices for the vertices of the blendshape for which the quantized normalized values are encoded.

7. The method of claim 6, further comprising calculating the transformation matrix, wherein calculating the transformation matrix includes:
calculating a centroid for the base mesh;
calculating a centroid for the blendshape; and
calculating a vector to align the centroid for the base mesh with the centroid for the blendshape.

8. The method of claim 7, wherein calculating the centroid for the base mesh includes, for each of N vertices of the base mesh, calculating the centroid according to:
$$centroid = \frac{1}{N} {\sum }_{i = 1}^{N} {vertex}_{i} .$$

9. The method of claim 6, wherein calculating the transformation matrix includes calculating a scale value for scaling vertices of the blendshape to vertices of the base mesh according to:
$$scale = \frac{{blendshape}_{RMS}}{{base}_{RMS}} .$$

10. The method of claim 6, wherein calculating the transformation matrix includes calculating a rotation to rotate the blendshape to match a rotation of the base mesh.

11. The method of claim 6, wherein calculating the transformation matrix comprises calculating a 4×4 transformation matrix.

12. The method of claim 1, wherein encoding the blendshape includes:
calculating differences between positions of vertices of the blendshape and vertices of the base mesh; and
encoding difference values for the vertices of the blendshape when the vertices have differences greater than a threshold value.

13. The method of claim 12, wherein the threshold value comprises 10⁻⁵.

14. The method of claim 1, wherein encoding the blendshape includes:
calculating differences between positions of vertices of the blendshape and vertices of the base mesh;
determining minimum values and maximum values for coordinates of the differences; and
calculating normalized values that normalize the differences to fit within a range of values for each dimension according to:
$$normalized\_value = \frac{value - min}{max - min} .$$

15. The method of claim 14, further comprising quantizing the normalized values to quantized values having a specified bit depth according to:
$$quantized\_value = round ( normalized\_value * ( {2}^{bits} - 1 ) ) .$$

16. The method of claim 15, wherein the specified bit depth comprises one of 8 bits, 12 bits, or 16 bits.

17. The method of claim 1, wherein encoding the blendshape further comprises entropy encoding parameters for the blendshape.

18. The method of claim 17, wherein entropy encoding the parameters comprises entropy encoding the parameters using one of zlib or a Huffman entropy encoding algorithm.

19. A device for communicating augmented reality (AR) media data, the device comprising:
a memory configured to store AR media data; and
a processing system implemented in circuitry and configured to:
encode a blendshape for a base mesh of an avatar of the AR media data to form an encoded blendshape,
and
sending the base mesh and the encoded blendshape to a receiving device for an AR communication session.

20. The device of claim 19, wherein the receiving device comprises a digital asset repository, and wherein the processing system is further configured to send access information to the digital asset repository granting access to the base mesh and the encoded blendshape to one or more participants in the AR communication session.

21. The device of claim 19, wherein to encode the blendshape, the processing system is configured to:
encode a transformation matrix, including:
calculate a centroid for the base mesh;
calculate a centroid for the blendshape; and
calculate a vector to align the centroid for the base mesh with the centroid for the blendshape;
encode quantized normalized values representing differences between vertices of the blendshape and corresponding vertices of the base mesh; and
encode indices for the vertices of the blendshape for which the quantized normalized values are encoded.

22. The device of claim 19, wherein to encode the blendshape, the processing system is further configured to:
calculate differences between positions of vertices of the blendshape and vertices of the base mesh; and
encode difference values for the vertices of the blendshape when the vertices have differences greater than a threshold value.

23. A method of communicating augmented reality (AR) media data, the method comprising:
receiving a base mesh of an avatar of AR media data and an avatar representation format data structure including an encoded blendshape relative to the base mesh for an AR communication session;
decoding the encoded blendshape to reproduce a blendshape that is decoded; and
presenting the blendshape during the AR communication session to depict an animated version of the avatar.

24. The method of claim 23, wherein decoding the encoded blendshape comprises:
decoding a transformation matrix;
decoding quantized normalized values representing differences between vertices of the blendshape and corresponding vertices of the base mesh;
inverse quantizing the quantized normalized values for the vertices of the blendshape; and
decoding indices for the vertices of the blendshape for which the quantized normalized values are encoded.

25. The method of claim 23, further comprising recalculating vertex normals for the blendshape.

26. The method of claim 25, wherein recalculating the vertex normals includes:
computing face normals for faces of the blendshape; and
for each vertex of the blendshape, averaging the face normals for each of the faces that are adjacent to the vertex.

27. The method of claim 23, further comprising:
joining the AR communication session having a participant corresponding to the avatar;
receiving, via the AR communication session, data indicating that the blendshape is to be presented for the participant; and
presenting the blendshape in response to receiving the data indicating that the blendshape is to be presented.

28. A device for communicating augmented reality (AR) media data, the device comprising:
a memory configured to store AR media data; and
a processing system implemented in circuitry and configured to:
receive a base mesh of an avatar of AR media data and an avatar representation format data structure including an encoded blendshape relative to the base mesh for an AR communication session;
decode the encoded blendshape to reproduce a blendshape that is decoded; and
present the blendshape during the AR communication session to depict an animated version of the avatar.

29. The device of claim 28, wherein to decode the encoded blendshape, the processing system is configured to:
decode a transformation matrix;
decode quantized normalized values representing differences between vertices of the blendshape and corresponding vertices of the base mesh;
inverse quantize the quantized normalized values for the vertices of the blendshape; and
decode indices for the vertices of the blendshape for which the quantized normalized values are encoded.

30. The device of claim 28, wherein the processing system is further configured to:
join the AR communication session having a participant corresponding to the avatar;
receive, via the AR communication session, data indicating that the blendshape is to be presented for the participant; and
present the blendshape in response to receiving the data indicating that the blendshape is to be presented.
